(19) United States
(12) Patent Application Publication
(10) Pub. No.: US 2012/0104181 A1
(43) Pub. Date: May 3, 2012

(54) Cross-Sectionally Morphing Airfoil

(75) Inventor: Matthew Boyd Rix, Cresson, TX (US)

(73) Assignee: Matthew Boyd Rix, Cresson, TX (US)

(21) Appl. No.: 12/938,352

(22) Filed: Nov. 2, 2010

(51) Int. Cl. B64C 3/44

(52) U.S. Cl. 244/219

(57) ABSTRACT

The present invention provides an apparatus, system, and method for morphing the cross-sectional shape of an airfoil between a high-speed, low-lift airfoil and a low-speed, high-lift airfoil, including interim airfoil configurations, to allow for optimal performance. This is done by inputting a control command into the system that alters the shape of the split or elastic upper and/or lower skin surface to allow the airfoil camber and chord to vary.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present invention relates generally to aeronautical vehicle systems and more specifically to the shape and composition of an airfoil and a method for altering the cross-sectional shape and/or size of the airfoil.

### BACKGROUND OF THE INVENTION

An airfoil is the cross-sectional shape of a lifting body. When designing a lifting body, the airfoil is selected to allow the lifting body to perform optimally for its primary mission. There are always tradeoffs between different airfoils. For example, in an airplane application, an airfoil chosen for a high-speed airplane will inherently require a longer runway and higher airspeeds when landing due to the lower total lift produced. And in turn, an airfoil that provides a large amount of lift at low speeds will allow an airplane to land on very small airstrips but limit the aircraft speed and fuel economy at cruise.

Wing morphing is intentionally altering the shape of the wing during flight. Wing morphing is a concept believed to be extremely beneficial because it allows the wing shape to be changed and optimized for multiple stages of an aircraft's mission. Currently, airfoils are changed during flight primarily by the use of control surfaces such as flaps, slats, ailerons, elevators, or rudders. These surfaces function by deflecting, extending, or retracting at the leading or trailing edge of the airfoil thus changing the overall chord and/or camber of the lifting body. This increases or decreases lift (and/or drag), and in turn, affects the attitude (induces pitch, yaw, or roll) and performance of the aircraft.

Current methods used to change the shape of airfoils add weight and complexity to aircraft and other airfoil applications. Therefore, it is desirable to create a method that will simplistically modify the shape of an airfoil without significantly increasing the weight. The present invention provides a method that allows for a wider range of optimal characteristics and increases the capability of an airfoil.

### BRIEF SUMMARY OF THE INVENTION

The present invention provides an apparatus, system, and method for morphing the cross-sectional shape of an airfoil.

This morphing airfoil was designed to allow optimal airfoil performance during all phases of flight including but not limited to takeoff, cruise, loiter and landing. Design criteria required a smooth transition between two airfoils while maintaining structural rigidity. Other design goals included mechanical simplicity and low overall weight.

The present invention includes a structural main spar with a mechanism that rotates a split or elastic upper and/or lower surface to allow the airfoil camber and chord to vary. Applied to an aircraft, the present invention has several applications including but not limited to the following: During takeoff and landing, when a lot of lift is required, the lifting body would be configured with the high-lift airfoil. During cruise, the lifting body would be shifted to a low-drag configuration to allow for better cruise performance. The present invention also allows split control of the right and left portions of the lifting body to allow them to morph independently and serve as roll authority eliminating the need for ailerons as well as producing greater total lift when required. All other airfoil surfaces could implement the same concept to add control authority in a simple and efficient manner.

### BRIEF DESCRIPTION OF THE DRAWINGS

FIG. 1 is a perspective view of a wing section that utilizes a morphing airfoil in accordance with the embodiment of the present invention.

FIG. 2 is a cross-sectional view of a typical mechanization of airfoil morphing in accordance with the embodiment of the present invention.

### DETAILED DESCRIPTION OF THE PREFERRED EMBODIMENT

It should be understood that the present invention is not limited to the aerospace application described in this embodiment. It may be adapted to include, but not limited to, any other aerospace application, ground vehicle application, watercraft application, or any other use and/or application of an airfoil.

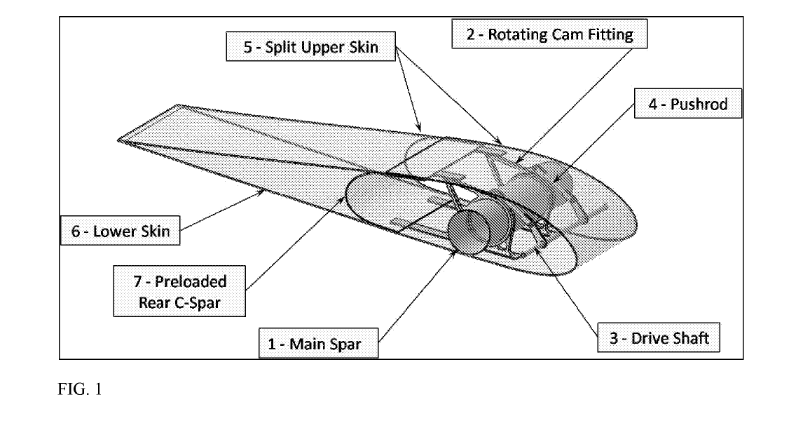

FIG. 1 is a perspective view of a wing section that utilizes a morphing airfoil in accordance with the embodiment of the present invention. The embodiment of the present invention includes a main spar (1) that allows for a rotational fitting (2) to pivot with the rotation of a drive shaft (3). The rotation is shown in this embodiment as being driven by a drive shaft (3) translating a push rod (4), however it should be understood that the present invention is not limited to this method of imposed rotation. The present invention would include any form of input that would result in the desired upper skin (5) motion or change in shape and/or camber.

In this embodiment of the present invention, the upper skin (5) of the airfoil is split forward and aft and overlaps; this allows the wing camber and chord to vary. With advances in materials, airfoil components can be flexible and still maintain structural load-bearing capability. In this embodiment, the airfoil skins are of fiberglass composite construction, however it should be understood that the present invention is not limited in material selection. It is conceived that several different materials or combinations of materials could meet the strength, flexibility, and rigidity requirements and could be used for the construction of the skins. It is also conceived that the skin material could be elastic in nature and not require the upper and/or lower skin to be split.

This embodiment of the present invention also includes a structural fiberglass lower skin (6) and a preloaded fiberglass rear C-spar (7). It is conceived that several different materials could be used for the construction of the airfoil components, and again, it should be understood that the present invention is not limited to the materials presented in this embodiment. The purpose of the C-spar (7) in this embodiment is to preload the aft portion of the upper skin to ensure positive engagement between the forward and aft sections of the upper skins (5). It is conceived that within the parameters of the present invention, there are several other methods that could be applied to ensure the positive engagement of the forward and aft sections of the upper skin (5).

It is also conceived that the present invention could apply the same methodology described in this embodiment—of changing the shape and/or camber of the upper skin (5)—to change the shape and/or camber of the lower skin (6). It is conceived that the present invention could be applied to the upper (5) and lower (6) skins together and/or individually.

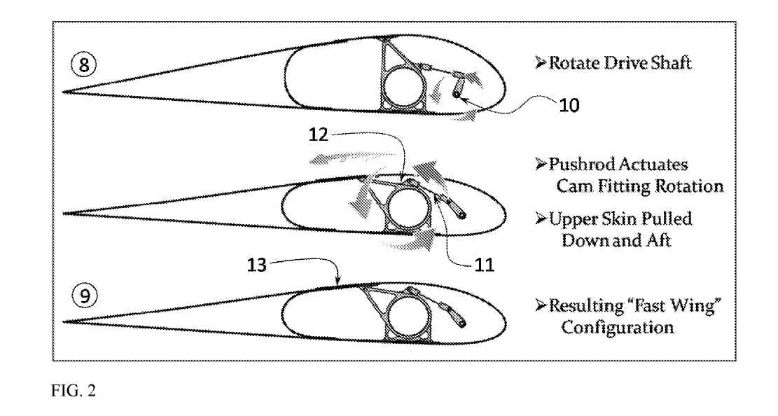

FIG. 2 demonstrates the mechanization of the embodiment of the present invention. The airfoil is shown transitioning from the high-lift configuration (8) to the low-drag configuration (9), however, it is understood that the reverse mechanization would alter the airfoil from the low-drag configuration (9) to the high-lift configuration (8). It is understood that partial mechanization would result in interim airfoil shapes, and it is conceived that mechanization control inputs could be of step nature or fluid and continual to alter the configuration continuously to obtain the optimal airfoil shape in all situations and environments.

Mechanization begins with a control input that is delivered through the drive shaft (10), and the resulting rotation translates the pushrod (11). This actuates the cam fitting (12) which rotates and pulls the upper skin (13) down and aft. The resulting configuration is the low drag airfoil (9). Thus, in the embodiment of the present invention, the lift is increased or decreased as required through control inputs delivered through the forward drive shaft (10).

What is claimed is:

1. An airfoil comprising of an upper and/or lower skin that morphs in shape between a high-speed, low-lift airfoil and a low-speed, high-lift airfoil, including interim airfoil configurations, to allow for optimal performance by inputting a control command into the system that alters the shape of the upper and/or lower skin.

2. The airfoil of claim 1, where the upper and/or lower skin is either split fore and aft and overlaps or is elastic in nature to allow for the camber of the airfoil to be altered.

3. The airfoil of claim 2 that contains a main structural spar or member with a mechanism that alters the upper and/or lower skin to allow the airfoil camber and chord to vary.

4. The airfoil of claim 3 where the internal components and mechanism of the airfoil, when combined with the upper and lower skins, are constructed of materials structurally sufficient to withstand the static and dynamic loads required for airfoil performance.
